(19) United States
(12) Patent Application Publication
(10) Pub. No.: US 2026/0214352 A1
(43) Pub. Date: Jul. 23, 2026

(54) THERMOGRAPHIC BAD PIXEL DETECTION METHOD AND DEVICE

(71) Applicant: CREATIVE SENSOR INC., Taipei City (TW)

(72) Inventors: Chih-Hao MA, Taipei City (TW); Yu-Huan SUNG, Taipei City (TW)

(73) Assignee: CREATIVE SENSOR INC., Taipei City (TW)

(21) Appl. No.: 19/034,294

(22) Filed: Jan. 22, 2025

(51) Int. Cl. H04N 25/671; G01J 5/00; G01J 5/48; G01J 5/90; H04N 25/21; H04N 25/68

(52) U.S. Cl. CPC H04N 25/671; G01J 5/48; G01J 5/90; H04N 25/21; H04N 25/68; G01J 2005/0077

(57) ABSTRACT

A thermographic bad pixel detection method is disclosed, which includes: by a data capturing circuit, capturing a raw image from a thermographic device; by a processor, performing a non-uniformity correction algorithm on the raw image to generate multiple respective correction coefficients of multiple pixels in the raw image; by the processor, generating multiple feature coordinates in a feature space based on pixel values of each pixel in the raw image and the multiple correction coefficients of each pixel; by the processor, performing outlier detection on the multiple feature coordinates to generate at least one outlier coordinate as at least one bad pixel coordinate, where the at least one bad pixel coordinate indicates that at least one of the pixels corresponding to the at least one bad pixel coordinate in the raw image is abnormal.

### BACKGROUND OF THE DISCLOSURE

### Technical Field

The disclosure relates to a thermographic processing technique, particularly relates to a thermographic bad pixel detection method and device.

### Description of Related Art

Thermographic technology is prone to faults or abnormal responses on sensors in a thermographic device due to process issues, and such problems often cause bad pixels to appear in images photographed by the thermographic device. Therefore, previous bad pixel detection manners compare difference degree between pixel value of each pixel and surrounding adjacent pixels to determine whether the pixel is abnormal. However, the previous manner simply utilizes the pixel values to identify the bad pixels, which causes a higher risk of misidentifying. In addition, in order to prevent missed detection of the bad pixels, the previous manner continuously performs bad pixel detection during real-time imaging, thereby increasing burden on real-time computational resources. Therefore, how to provide a more accurate and efficient manner for detecting the bad pixels is an urgent problem that those skilled in the art eager to solve.

### SUMMARY OF THE INVENTION

The purpose of the disclosure is to provide a thermographic bad pixel detection method and device, which solves a problem of the prior art that must require performing bad pixel detection on each image to determine a bad pixel appeared on which pixel whenever the image is photographed by a thermographic device.

In order to achieve the above purpose, the disclosure provides a thermographic bad pixel detection method, including:
step a) by a data capturing circuit, capturing a raw image from a thermographic device;
step b) by a processor, performing a non-uniformity correction algorithm on the raw image to generate multiple respective correction coefficients of multiple pixels in the raw image;
step c) by the processor, generating multiple feature coordinates in a feature space based on pixel values of each of the pixels in the raw image and the multiple correction coefficients of each of the pixels; and
step d) by the processor, performing outlier detection on the multiple feature coordinates to generate at least one outlier coordinate as at least one bad pixel coordinate, where the at least one bad pixel coordinate indicates that at least one of the pixels corresponding to the at least one bad pixel coordinate in the raw image is abnormal.

In order to achieve the above purpose, the disclosure provides a thermographic bad pixel detection device, including:
a data capturing circuit, configured for capturing a raw image from a thermographic device;
a storage, configured for storing multiple instructions; and
a processor, connected to the data capturing circuit and the storage, and configured for accessing the multiple instructions to execute following actions:
   action a) performing a non-uniformity correction algorithm on the raw image to generate multiple respective correction coefficients of multiple of pixels in the raw image;
   action b) generating multiple feature coordinates in a feature space based on pixel values of each of the pixels in the raw image and the multiple correction coefficients of each of the pixels; and
   action c) performing outlier detection on the feature coordinates to generate at least one outlier coordinate as at least one bad pixel coordinate, where the at least one bad pixel coordinate indicates that at least one of the pixels corresponding to the at least one bad pixel coordinate in the raw image is abnormal.

Compared to the previous techniques, the disclosure not only utilizes the pixel values of the images generated by the thermographic device but also additionally utilizes coefficients of non-uniformity correction to calculate the feature coordinates of each pixel. Next, the disclosure utilizes an outlier algorithm to identify outlier feature points, and utilizes image pixels corresponding to the outlier feature points as the abnormal pixels (i.e., the bad pixels). In this way, the disclosure effectively improves accuracy of the bad pixel detection, completing accurate bad pixel detection during production calibration in one step, without repeatedly executing the bad pixel detection algorithm during real-time imaging to compensate for missed detection of the bad pixels.

### BRIEF DESCRIPTION OF THE DRAWINGS

FIG. 1 illustrates a block diagram of a thermographic bad pixel detection device in some embodiments of the disclosure.

FIG. 2 illustrates a flowchart of a thermographic bad pixel detection method in some embodiments of the disclosure.

FIG. 3 illustrates a schematic diagram of a raw image being converted into a corrected image in some embodiments of the disclosure.

FIG. 4 illustrates a schematic diagram of outlier detection in some embodiments of the disclosure.

FIG. 5 illustrates a schematic diagram of at least one pixel corresponding to at least one bad pixel coordinate in some embodiments of the disclosure.

### DETAILED DESCRIPTION

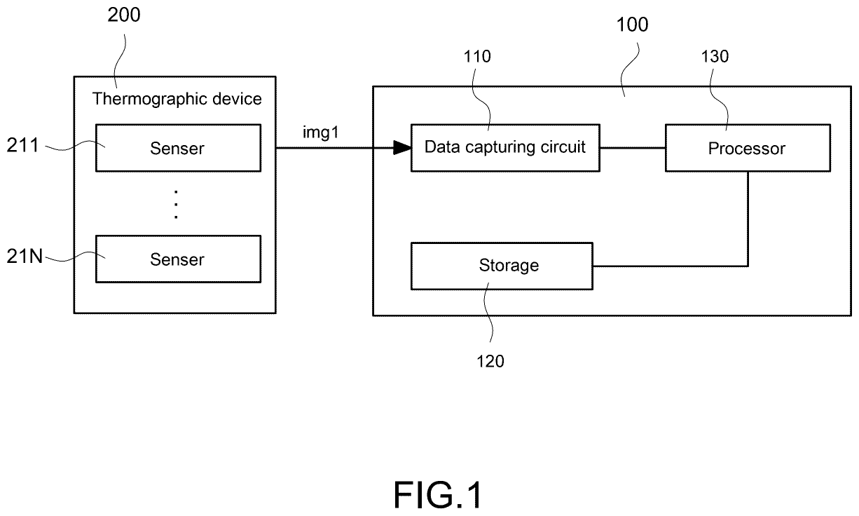

Reference is made to FIG. 1, and FIG. 1 illustrates a block diagram of a thermographic bad pixel detection device 100 in some embodiments of the disclosure. As shown in FIG. 1, in this embodiment, the thermographic bad pixel detection device 100 includes a data capturing circuit 110, a memory 120, and a processor 130. The processor 130 is coupled to the data capturing circuit 110 and the storage 120.

In some embodiments, the thermographic bad pixel detection device 100 is implemented by any data processing device (e.g., a desktop computer, a laptop, or a tablet computer) or any server (e.g., a cloud server, a virtual server, or a rack server). In this embodiment, the data capturing circuit 110 is used for capturing the raw image img1 from a thermographic device 200. In some embodiments, the raw image img1 is generated by the thermographic device 200 photographing a black body with a black body temperature in a detection field with an environment temperature. Specifically, a user utilizes the thermographic device 200 to photograph the black body with the specific black body temperature (e.g., equal to a room temperature of 25° C. or a higher temperature of 100° C.) in the detection field with the environment temperature (e.g., equal to the room temperature of 25° C.) to generate the raw image img1. Next, the thermographic bad pixel detection device 100 connects to the thermographic device 200 through the data capturing circuit 110 to capture the raw image img1 from the thermographic device 200.

In some embodiments, the detection field is a field (e.g., a laboratory or a closed indoor space) with a stable environment temperature, stable environment humidity, and no air flow. In addition, only the above black body is placed in the detection field, and no other objects are placed in the detection field. In some embodiments, the thermographic device 200 includes multiple sensors 211-21N, which are used for detecting thermal radiation in the detection field and respectively generating a respective pixel value of multiple pixels in the raw image img1. In other words, the sensors 211-21N respectively correspond to the multiple pixels in the raw image img1 (i.e., a one-to-one correspondence), and are used for generating the pixel values of the respective corresponding pixels, where N is a total number of all pixels in the raw image img1. In some embodiments, a correspondence relationship between the sensors 211-21N and the multiple pixels is pre-stored in the storage 120 (e.g., a mapping table storing the correspondence relationship between sensors 211-21N and the multiple pixels).

In some embodiments, the thermographic device 200 is implemented by any thermographic camera (e.g., a general infrared camera, a quantum instrument, or an optical and infrared composite camera). In some embodiments, the sensors 211-21N are implemented by any cooled or uncooled thermal radiation sensors. In some embodiments, the raw image img1 is any type of image (e.g., a grayscale image or a RGB image) generated by the thermographic device 200 without having undergone processes of a non-uniformity correction (NUC) algorithm and bad pixel detection described in following paragraphs. In some embodiments, the data capturing circuit 110 is any wireless communication circuit (e.g., a Wi-Fi communication circuit or a Bluetooth communication circuit) or any wired communication circuit (e.g., an Ethernet communication circuit) for communication.

It should be noted that the black body is an ideal object that absorbs all incident radiation (regardless of a radiation wavelength and an incident angle), does not reflect or transmit any light (i.e., reflectance and transmittance are zero), and uniformly emits thermal radiation. In addition, because the black body uniformly emits the thermal radiation, all pixels of a black body object in the raw image img1 theoretically have the same pixel value, and all pixels of a background part in the raw image img1 have another identical pixel value. These pixel values are considered as theoretical values. In some embodiments, the preset environment temperature, the preset black body temperature, and the preset correspondence relationship between temperatures and the pixel values are pre-stored in the storage 120. Therefore, the theoretical values for all pixels in the raw image img1 are calculated by the processor 130 based on the preset environment temperature, the preset black body temperature, and the preset correspondence relationship between the temperatures and the pixel values, where these theoretical values are used for calculating correction coefficients described in the following paragraphs.

However, the sensors 211-21N possibly have different sensitivities for the thermal radiation due to process errors, circuit aging, or malfunction. Based on this, some of the pixel values of the black body object in the raw image img1 and some of the pixel values in the background part in the raw image img1 possibly are not the above theoretical values. Therefore, the raw image img1 needs to undergo the non-uniformity correction algorithm and the bad pixel detection described in the following paragraphs.

In this embodiment, the storage 120 is used for storing multiple instructions. In some embodiments, the multiple instructions are implemented by any firmware or any software, and the processor 130 accesses these instructions to execute the thermographic bad pixel detection method described in the following paragraphs. In some embodiments, the storage 120 is implemented by a flash memory, a read-only memory (ROM), a hard disk, or any equivalent storage component. In some embodiments, the processor 130 is implemented by a central processing unit (CPU), a microcontroller unit (MCU), a programmable logic controller (PLC), a system on chip (SoC), or a field-programmable gate array (FPGA).

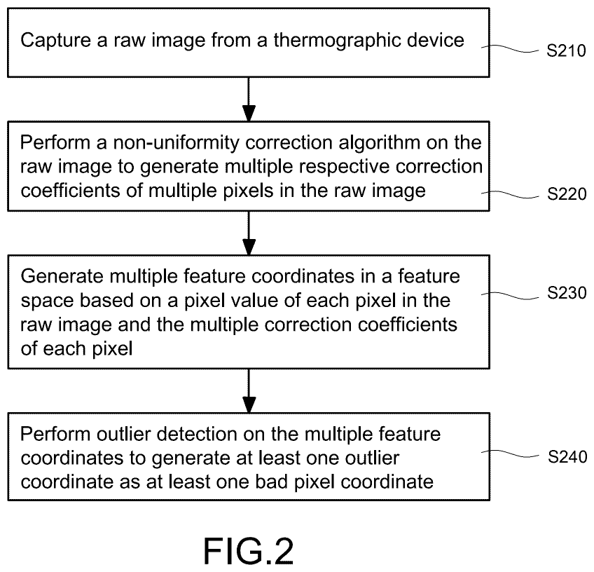

Reference is made to FIG. 2, and FIG. 2 illustrates a flowchart of the thermographic bad pixel detection method in some embodiments of the disclosure. This method is applicable to the thermographic bad pixel detection device 100 shown in FIG. 1. As shown in FIG. 2, the thermographic bad pixel detection method includes steps S210-S240.

First, in step S210, the data capturing circuit 110 captures the raw image img1 from the thermographic device 200. In step S220, the processor 130 performs the non-uniformity correction algorithm on the raw image img1 to generate the multiple respective correction coefficients of the multiple pixels in the raw image img1.

In some embodiments, the processor 130 calculates a gain coefficient and an offset coefficient of each pixel as the multiple correction coefficients of each pixel by a linear relationship between the pixel value of each pixel in the raw image img1 and the theoretical value of each pixel. In some embodiments, the linear relationship between the pixel value of each pixel and the theoretical value of each pixel is shown in a following formula (1):

$${Y}_{i j} = {a}_{ij} {X}_{i j} + {b}_{i j} \qquad formula ( 1 )$$

In formula (1), i is a horizontal coordinate of a pixel coordinate (i, j) in the pixel coordinate system of one of the pixels in the raw image img1, and j is a vertical coordinate of the pixel coordinate (i, j) in the pixel coordinate system of this pixel in the raw image img1, Yᵢⱼ is the theoretical value of this pixel, Xᵢⱼ is an actual pixel value of this pixel in the raw image img1, aᵢⱼ is the gain coefficient of this pixel, and bᵢⱼ is the offset coefficient of this pixel.

In some embodiments, the processor 130 calculates an error sum of squares (ESS) from multiple linear relationships respectively corresponding to the multiple pixels in the raw image img1, and minimizes this error sum of squares to generate the multiple respective correction coefficients of the multiple pixels. In some embodiments, the above error sum of squares is shown in formula (2) below:

$$E = {\sum }_{i = 1}^{S} {\sum }_{j = 1}^{T} ( {Y}_{i j} - {( {a}_{i j} {X}_{i j} + {b}_{i j} )}^{2} ) \qquad formula ( 2 )$$

In formula (2), S is the total number of the pixels in a horizontal direction of the raw image img1, T is the total number (i.e., S×T=N) of the pixels in a vertical direction of the raw image img1, and E is the error sum of the squares of the multiple linear relationships mentioned above.

In some embodiments, the processor 130 minimizes this error sum of the squares to calculate the gain coefficient and the offset coefficient of each pixel (i.e., the gain coefficient aᵢⱼ and the offset coefficient bᵢⱼ of the pixel at the coordinate (i, j)) as the multiple correction coefficients of each pixel by utilizing an algorithm such as a least squares method, stepwise regression, or maximum likelihood estimation (MLE). In some embodiments, the processor 130 further normalizes the gain coefficient and the offset coefficient of each pixel. Such normalization helps to improve subsequent processing efficiency and reduce effect of abnormal coefficient. In some embodiments, the above normalization is implemented by min-max normalization or Z-score normalization.

In some embodiments, the processor 130 converts the pixels of the raw image img1 into one corrected image by utilizing the multiple respective correction coefficients of the multiple pixels in the raw image img1. In some embodiments, the processor 130 generates a linear transformation formula of each pixel by utilizing the multiple correction coefficients of each pixel in the raw image img1 (i.e., similar to the above formula (1)), and converts the pixel value of each pixel in the raw image img1 into a pixel value of a corresponding pixel in the corrected image by utilizing the linear transformation formula of each pixel, where each pixel in the raw image img1 and the corresponding pixel in the corrected image have the same pixel coordinate.

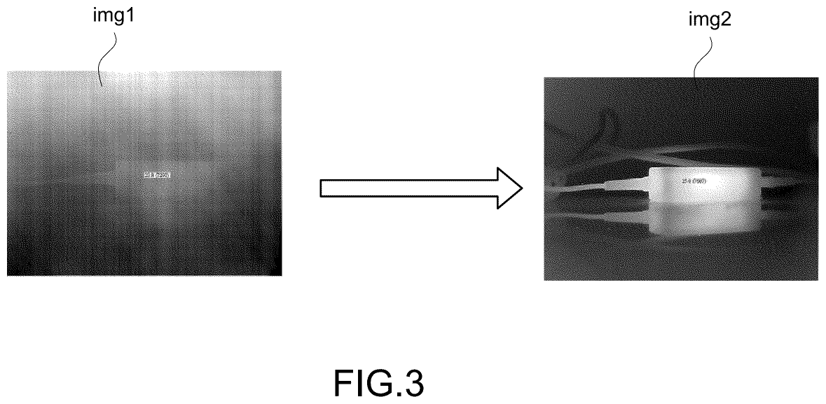

The raw image img1 and the corrected image are explained by a practical example below. Reference is made to FIG. 3, and FIG. 3 illustrates a schematic diagram of the raw image img1 being converted into the corrected image img2 in some embodiments of the disclosure. As shown in FIG. 3, the processor 130 corrects all pixels in the raw image img1 to generate all pixels in the corrected image img2 by utilizing the non-uniform correction algorithm. From the corrected image img2, it can be known that the non-uniform correction algorithm significantly eliminates thermographic bands, thermographic stripes, and thermographic noise. Therefore, distribution of the pixel value of the pixels in the corrected image img2 is greatly smoothed, and clarity of the pixel value of the pixels in the corrected image img2 is improved.

Returning to FIG. 2, in step S230, the processor 130 generates multiple feature coordinates in a feature space based on the pixel value of each pixel in the raw image img1 and the multiple correction coefficients (i.e., the gain coefficient aᵢⱼ and the offset coefficient bᵢⱼ) of each pixel. In some embodiments, the pixel values of the multiple pixels in the raw image img1 respectively correspond to the multiple feature coordinates. In some embodiments, the processor 130 respectively utilizes the pixel values of each pixel in the raw image img1 and the multiple correction coefficients of each pixel as multiple elements of each feature coordinate in the feature space. In some embodiments, the feature coordinate is shown in following formula (3):

$$( {V}_{i j} , {a}_{i j} , {b}_{i j} ) \qquad formula ( 3 )$$

In the formula (3), Vᵢⱼ is the pixel value of the pixel coordinates (i, j) in the raw image img1. In other words, a first element of the feature coordinate corresponding to one of the pixels is the pixel value of this pixel in the raw image img1, a second element of this feature coordinate is the gain coefficient of this pixel, and a third element of this feature coordinate is the offset coefficient of this pixel. Thereby, a three-dimensional space formed by these feature coordinates is viewed as the above feature space.

In step S240, the processor 130 performs outlier detection on the multiple feature coordinates to generate at least one outlier coordinate as at least one bad pixel coordinate, where the at least one bad pixel coordinate indicates that at least one pixel corresponding to the at least one bad pixel coordinate in the raw image img1 is abnormal. In other words, the processor 130 selects the at least one outlier coordinate from the multiple feature coordinates in the feature space as the at least one bad pixel coordinate by utilizing the outlier detection. Next, the processor 130 selects the at least one pixel (e.g., if the bad pixel coordinate is (V_{xy}, a_{xy}, b_{xy}), the pixel coordinates corresponding to the bad pixel coordinate is (x, y) in the raw image img1) corresponding to the at least one bad pixel coordinate in the feature space from the raw image img1, and identifies this at least one pixel as abnormal (i.e., impossibly corrected by the above non-uniform correction algorithm).

In some embodiments, the outlier detection is implemented by an algorithm such as a k-nearest neighbors (KNN) algorithm, a local outlier factor (LOF) algorithm, a density-based spatial clustering of applications with noise (DBSCAN) algorithm, a K-means algorithm, or a principal components analysis (PCA) algorithm.

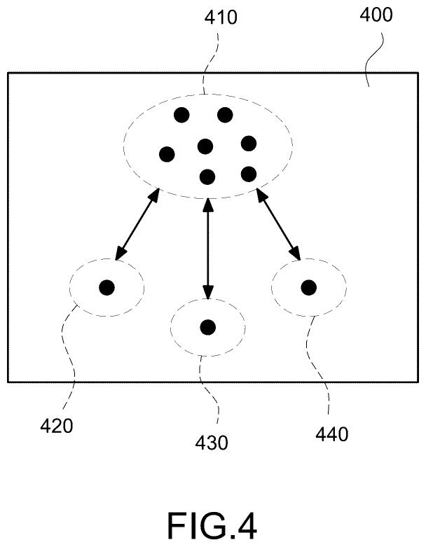

The outlier detection is explained by a practical example below. Reference is made to FIG. 4, and FIG. 4 illustrates a schematic diagram of the outlier detection in some embodiments of the disclosure. As shown in FIG. 4, the multiple feature coordinates exist in the feature space 400. The processor 130 performs the outlier detection on all feature coordinates, and identifies that most feature coordinates are in a cluster 410, while three outlier coordinates of the multiple feature coordinates are the bad pixel coordinates 420-440.

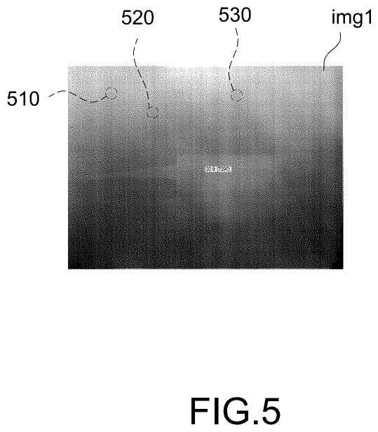

Reference is made to FIG. 5, and FIG. 5 illustrates a schematic diagram of the pixels 510-530 corresponding to the bad pixel coordinates 420-440 in some embodiments of the disclosure. As shown in FIG. 5, the processor 130 selects the three pixels 510-530 respectively corresponding to the three bad pixel coordinates 420-440 in the feature space 400 from the raw image img1. Next, the processor 130 identifies these three pixels 510-530 as abnormal pixels that cannot be corrected by the above non-uniform correction algorithm.

In some embodiments, the processor 130 selects the pixel corresponding to the at least one bad pixel coordinate from the raw image img1 as the at least one abnormal pixel. Next, the processor 130 calculates at least one replacement value as the pixel value of the at least one abnormal pixel based on the pixel values of the multiple pixels surrounding the at least one abnormal pixel. In some embodiments, the processor 130 randomly selects the pixel value of one of the pixels from the multiple pixels surrounding the at least one abnormal pixel as the at least one replacement value. For example, the processor 130 selects a 3×3 pixel region centered on one abnormal pixel, and randomly selects the pixel value of one of the pixels excluding the abnormal pixel in this region as the above replacement value.

In other embodiments, the processor 130 calculates an average pixel value of the multiple pixels surrounding the at least one abnormal pixel as the at least one replacement value. For example, the processor 130 selects the 3×3 pixel region centered on one abnormal pixel, and calculates the average pixel value of all pixels excluding the abnormal pixel in this region as the above replacement value.

In some embodiments, the processor 130 identifies the sensor corresponding to the at least one abnormal pixel as abnormal. For example, continuing with the example in FIG. 5, assuming the pixel values of the abnormal pixels 510-530 are respectively detected by the sensors 211-213, the processor 130 identifies that the abnormal pixels 510-530 correspond to the sensors 211-213 based on the correspondence relationship between the sensors 211-21N and all pixels in the raw image img1 stored in storage 120. Next, the processor 130 identifies that the sensors 211-213 are in an abnormal condition at this time, and stores this identification result in the storage 120. In some embodiments, the thermographic bad pixel detection device 100 periodically or non-periodically executes the above steps to update the identification results stored in the storage 120. In this way, when the thermographic device 200 photographs a new image again, the processor 130 identifies that the sensors 211-213 have been abnormal based on the identification result stored in the storage 120, and identifies the pixels corresponding to the sensors 211-213 in the new image as the bad pixels. As a result, the disclosure avoids performing bad pixel detection on the photographed image to determine which pixel is a bad pixel whenever an image is photographed by the thermographic device 200 in the future.

In summary, the thermographic bad pixel detection method and device in the disclosure combine the non-uniform correction algorithm with the outlier detection in the feature space to identify the bad pixel coordinates indicating the abnormal pixels corresponding to the bad pixel coordinates in the raw image. In this way, the disclosure is no longer necessary to perform the bad pixel detection on the new photographed images to determine where the bad pixels appear, and utilizes the replacement values to replace the pixel values of the bad pixels. In addition, the thermographic bad pixel detection method and device in the disclosure pre-store the correspondence relationship between the sensors in the thermographic device and the pixels, and identify the sensors being abnormal from the abnormal pixels based on this correspondence relationship. As a result, the user immediately knows which sensors are abnormal and take further action to replace or repair the sensors being abnormal.

While this disclosure has been described by means of specific embodiments, numerous modifications and variations may be made thereto by those skilled in the art without departing from the scope and spirit of this disclosure set forth in the claims.

What is claimed is:

1. A thermographic bad pixel detection method, comprising:
step a) by a data capturing circuit, capturing a raw image from a thermographic device;
step b) by a processor, performing a non-uniformity correction algorithm on the raw image to generate a plurality of respective correction coefficients of a plurality of pixels in the raw image;
step c) by the processor, generating a plurality of feature coordinates in a feature space based on pixel values of each of the pixels in the raw image and the plurality of correction coefficients of each of the pixels; and
step d) by the processor, performing outlier detection on the plurality of feature coordinates to generate at least one outlier coordinate as at least one bad pixel coordinate, wherein the at least one bad pixel coordinate indicates that at least one of the pixels corresponding to the at least one bad pixel coordinate in the raw image is abnormal.

2. The thermographic bad pixel detection method of claim 1, wherein the raw image is generated by the thermographic device photographing a black body with a black body temperature in a detection field with an environmental temperature, and the thermographic bad pixel detection method further comprises:
by the processor, selecting the pixel corresponding to the at least one bad pixel coordinate from the raw image as at least one abnormal pixel; and
by the processor, calculating at least one replacement value as the pixel value of the at least one abnormal pixel based on the pixel values of the pixels surrounding the at least one abnormal pixel.

3. The thermographic bad pixel detection method of claim 1, wherein step b) comprises:
by the processor, calculating a gain coefficient and an offset coefficient of each of the pixels as the plurality of correction coefficients for each of the pixels based on a linear relationship between the pixel value of each of the pixels in the raw image and a theoretical value of each of the pixels.

4. The thermographic bad pixel detection method of claim 1, wherein step c) comprises:
by the processor, respectively utilizing the pixel values of each of the pixels in the raw image and the plurality of correction coefficients of each of the pixels as a plurality of elements of the feature coordinates in the feature space.

5. The thermographic bad pixel detection method of claim 1, wherein the thermographic device comprises a plurality of sensors respectively corresponding to the plurality of pixels in the raw image, and the thermographic bad pixel detection method further comprises:
by the processor, selecting the pixel corresponding to the at least one bad pixel coordinate from the raw image as at least one abnormal pixel; and
by the processor, identifying at least one of the sensors corresponding to the at least one abnormal pixel as abnormal.

6. A thermographic bad pixel detection device, comprising:
a data capturing circuit, configured for capturing a raw image from a thermographic device;
a storage, configured for storing a plurality of instructions; and
a processor, connected to the data capturing circuit and the storage, and configured for accessing the plurality of instructions to execute following actions:
action a) performing a non-uniformity correction algorithm on the raw image to generate a plurality of respective correction coefficients of a plurality of pixels in the raw image;
action b) generating a plurality of feature coordinates in a feature space based on pixel values of each of the pixels in the raw image and the plurality of correction coefficients of each of the pixels; and
action c) performing outlier detection on the feature coordinates to generate at least one outlier coordinate as at least one bad pixel coordinate, wherein the at least one bad pixel coordinate indicates that at least one of the pixels corresponding to the at least one bad pixel coordinate in the raw image is abnormal.

7. The thermographic bad pixel detection device of claim 6, wherein the raw image is generated by the thermographic device photographing a black body with a black body temperature in a detection field with an environmental temperature, and the processor is further configured for executing following actions:
selecting the pixel corresponding to the at least one bad pixel coordinate from the raw image as at least one abnormal pixel; and
calculating at least one replacement value as the pixel value of the at least one abnormal pixel based on the pixel values of the pixels surrounding the at least one abnormal pixel.

8. The thermographic bad pixel detection device of claim 6, wherein the processor is configured for executing following action in action a):
calculating a gain coefficient and an offset coefficient of each of the pixels as the plurality of correction coefficients for each of the pixels based on a linear relationship between the pixel value of each of the pixels in the raw image and a theoretical value of each of the pixels.

9. The thermographic bad pixel detection device of claim 6, wherein the processor is configured for executing the following action in action b):
respectively utilizing the pixel values of each of the pixels in the raw image and the plurality of correction coefficients of each of the pixels as a plurality of elements of the feature coordinates in the feature space.

10. The thermographic bad pixel detection device of claim 6, wherein the thermographic device comprises a plurality of sensors respectively corresponding to the plurality of pixels in the raw image, and the processor is further configured for executing following actions:
selecting the pixel corresponding to the at least one bad pixel coordinate from the raw image as at least one abnormal pixel; and
identifying at least one of the sensors corresponding to the at least one abnormal pixel as abnormal.
